(19) United States
(12) Patent Application Publication
(10) Pub. No.: US 2020/0238349 A1
(43) Pub. Date: Jul. 30, 2020

(54) PROCESS FOR IMMOBILIZING HAZARDOUS WASTE

(71) Applicant: Techvault Pty Ltd, Sydney, New South Wales (AU)

(72) Inventors: Michael David Ingram, East Perth, Western Australia (AU); Lincoln Morton, Roleystone, Western Australia (AU)

(21) Appl. No.: 16/756,828

(22) PCT Filed: Oct. 17, 2018
(86) PCT No.: PCT/AU2018/051127

§ 371 Date: Apr. 16, 2020

(30) Foreign Application Priority Data
Oct. 17, 2017 (AU) 2017904196
Oct. 3, 2018 (AU) 2018903733

(51) Int. Cl. B09B 3/00; B09B 1/00; C02F 11/00; G21F 9/16; G21F 9/24; G21F 9/30; G21F 9/34; B01J 20/12; B01J 20/28; C04B 28/04; C04B 14/10; C04B 18/18

(52) U.S. Cl. CPC B09B 3/0041; B09B 1/008; C02F 11/008; G21F 9/165; G21F 9/24; G21F 9/304; C02F 2101/006; B01J 20/12; B01J 20/2803; C04B 28/04; C04B 14/106; C04B 18/18; G21F 9/34

(57) ABSTRACT

A process for immobilizing hazardous waste includes mixing the hazardous waste with a non-swelling clay, a cementitious binder and, optionally, water, and allowing the resulting mixture to set to an immobilized waste material. The process can also include dispersing the hazardous waste in the non-swelling clay to form a dry mixture, mixing the cementitious binder and, optionally, water with the dry mixture to produce a plastic mixture, and allowing the plastic mixture to set to the immobilized waste material.

### TECHNICAL FIELD

The disclosure relates to a process for immobilising hazardous waste, in particular hazardous liquid waste which consists of, or is contaminated with, one or more organic compounds, inorganic compounds, or naturally occurring radioactive materials.

### BACKGROUND

The discussion of the background to the disclosure is intended to facilitate an understanding of the disclosure. However, it should be appreciated that the discussion is not an acknowledgement or admission that any of the material referred to was published, known or part of the common general knowledge as at the priority date of the application.

A hazardous waste, in the Hazardous Waste in Australia 2017 Report, 30 May 2017, prepared for the Department of the Environment and Energy is defined as a waste that, by its characteristics, poses a threat or risk to public health, safety or to the environment. In national reporting this term is taken to correspond with: wastes that cannot be imported or exported from Australia without a permit under the Hazardous Waste (Regulation of Exports and Imports) Act 1989; wastes that any jurisdiction regulates as requiring particularly high levels of management and control, namely: regulated waste (Old); trackable waste (NSW); prescribed waste (Vic); listed waste (SA and NT); or controlled waste (ACT, Tas and WA); additional wastes nominated as hazardous by the Australian Government. The term ‘hazardous waste’ as used herein includes, but is not limited to, hazardous (chemical) wastes and low level radioactive wastes (LLW).

There are a range of industrial processes and activities that generate hazardous waste, in particular waste which consist of, or are contaminated with, one or more organic compounds, inorganic compounds, or low level radioactive wastes (LLW) such as naturally occurring radioactive materials (NORMs) or disused sealed radioactive sources (DSRS). Such processes and activities may include intentional manufacture, or arise as by-products of manufacturing facilities of products and articles such as plastics, paint, ink, pulp and paper, machinery and equipment, upholstery, textiles, packaging material, electrical/electronic equipment, master batches, pellets, expanded polystyrene materials, paints, glass, fertiliser and agrichemicals, food products, adhesives, wood products and so forth. Hazardous waste may arise in a wide variety of processes including, but not limited to, metal coating and finishing operations, petroleum refining, metal extraction, smelting and refining, coal mining, use of pesticides or herbicides, tanning and wool scouring, fossil fuel electricity generation, meat, poultry and dairy processing,

Examples of liquid hazardous wastes include, but are not limited to, obsolete liquid stockpiles of banned or restricted organic chemicals, liquid collected from spills, industrial wastewater, municipal wastewater, landfill and dumpsite leachates, industrial liquids (e.g. solvent), liquid household products, liquid fluids (e.g. insulating oils and hydraulic fluids), industrial or municipal sludges, residues from wastewater cleaning and residues from air pollution control systems.

One particular class of hazardous organic waste comprises persistent organic pollutants (POPs) which are organic compounds that are resistant to environmental degradation through chemical, biological and phytolytic processes and which consequently remain intact for exceptionally long periods of time (many years). They are toxic to both humans and wildlife and they bioaccumulate in the fatty tissue of living organisms including humans, and may be found at higher concentrations at high levels in the food chain.

Effects of POPs exposure in humans may range from persistent skin irritation to liver damage and damage to the central nervous system. Previous use of POPs has led to widespread environmental contamination. Legacy stockpiles have proven difficult to dispose due to the persistent nature of the materials and limited availability of isolation facilities.

Waste containing persistent organic pollutants must be disposed in such a way that they are immobilised or destroyed. Disposal options for POP-containing wastes may include thermal destruction via high temperature incineration, plasma arc furnace, and so forth; adsorption onto suitable media which must then be disposed; or immobilisation and disposal in a suitable repository.

Immobilisation of hazardous waste may be complex, not only because of the wide variety of hazardous waste but because they are discarded in various forms. For example, although some hazardous waste is predominantly organic, hazardous waste may reside in an aqueous matrix. Still others may be in combination with other solids and liquids, or take the form of oil-in-water emulsions or water-in-oil emulsions.

In the immobilisation process, hazardous waste should be properly packaged for ease of transport.

Secondly, stabilisation and solidification of hazardous waste, particularly in liquid form, is desirable for long term storage. Stabilisation of hazardous waste refers to the chemical conversion of the hazardous constituents in the waste to less soluble, mobile or toxic materials. The solidification of liquid waste refers to changes in the physical properties of the liquid waste to increase its compressive strength, decrease its permeability and encapsulate its hazardous constituents. Many liquid waste streams require pre-treatment or special additives prior to stabilisation and solidification. It will be appreciated that solid particulate hazardous waste, such as contaminated soil, may also undergo stabilisation and solidification.

Various embodiments of the present disclosure seek to provide an improved process for immobilising hazardous waste, in particular hazardous liquid waste including organic compounds and/or POPs, inorganic compounds, or low level radioactive waste.

### SUMMARY

The disclosure provides a process for immobilising hazardous waste, in particular hazardous liquid waste comprising or contaminated with hazardous organic compounds and/or POPs, inorganic compounds, or low level radioactive waste.

One aspect of the disclosure provides a process for immobilising hazardous waste comprising mixing said hazardous waste with a non-swelling clay, a cementitious binder and, optionally, water and allowing the resulting mixture to set.

In one embodiment, the process comprises:
a) dispersing said hazardous waste in the non-swelling clay to form a dry mixture,
b) mixing the cementitious binder and, optionally, water with the dry mixture to produce a plastic mixture: and
c) allowing the plastic mixture to set to an immobilised waste material.

In one embodiment, the process further comprises compressing the plastic mixture in a mould prior to step c).

In one embodiment, the non-swelling clay comprises kaolin. The kaolin may have a particle size P₉₅<1000 μm, or a particle size P₉₅<500 μm, or even a particle size P₉₅<250 μm.

In one embodiment, the dry mixture may comprise up to 85 wt % hazardous waste. In some embodiments, the amount of hazardous waste in the dry mixture may be up to at least 10 wt %, 20 wt %, 30 wt %, 40 wt %, 50 wt %, 60 wt %, 70 wt %, 80 wt %, 83 wt % and 85 wt % and further in a range of at least 10 to 20 wt %, 20 to 30 wt %, 30 to 40 wt %, 40 to 50 wt %, 50 to 60 wt %, 60 to 70 wt %, 70 to 80 wt %, 80 to 83 wt %, 83-85 wt %.

In one particular embodiment, said hazardous waste may comprise POPs.

In other embodiments, said hazardous waste may comprise organic liquids or aqueous liquids contaminated with one or more hazardous organic compounds, metals, inorganic compounds, or low level radioactive waste.

In one embodiment, the cementitious binder may be a hydraulic cement selected from a group comprising Ordinary Portland cement (OPC), Portland-slag cement, Portland-pozzolan cement, calcined gypsum, gypsum plaster, Plaster of Paris, calcium sulphate hemihydrate, slag cement, natural cement, masonry cement, sulphate-resistant cement, cement kiln dust, lime kiln dust, spent pot liner, or fly ash.

In one particular embodiment, the plastic mixture may be allowed to set for a sufficient period of time for the immobilised waste material to achieve an unconstrained compression strength of 0.05 MPa or more. In some embodiments, the unconstrained compression strength may be 0.05 MPa, 0.1 MPa, 0.15 MPa, 0.2 MPa, 0.3 MPa, 0.4 MPa, 0.5 MPa or more, and further in a range of 0.05-0.1 MPa, 0.1-0.15 MPa, 0.15-0.2 MPa, 0.2-0.3 MPa, 0.3-0.4 MPa, 0.4-0.5 MPa, or 0.5 MPa.

The period of time may be up to 96 hours. In some embodiments, the period of time may be 24 hours, 36 hours, 48 hours, 60 hours, 72 hours, 84 hours or 96 hours, and further in a range of from 24 to 96 hours, from 36 to 72 hours, or from 48 to 60 hours.

A further aspect of the disclosure provides an immobilised waste material comprising hazardous waste mixed with a non-swelling clay, a cementitious binder and, optionally, water.

In one embodiment, the immobilised waste material may comprise up to 80 wt % hazardous waste. In some embodiments, the amount of hazardous waste in the dry mixture may be up to at least 10 wt %, 20 wt %, 30 wt %, 40 wt %, 50 wt %, 60 wt %, 70 wt % and 80 wt %, and further in a range of at least 10 to 20 wt %, 20 to 30 wt %, 30 to 40 wt %, 40 to 50 wt %, 50 to 60 wt %, 60 to 70 wt %, 70 to 80 wt %.

In one embodiment, the immobilised waste material may comprises from 60 wt % to 80 wt % non-swelling clay.

In one embodiment, the immobilised waste material may comprise up to 20 wt % cementitious binder. In some embodiments, the amount of cementitious binder in the immobilised waste material may be up to at least 2 wt %, 5 wt %, 10 wt %, 12 wt %, 15 wt %, 18 wt % and 20 wt %, and further in a range of 2-5 wt %, 5-8 wt %, 8-10 wt %, 10-12 wt %, 12-15 wt %, 15-18 wt %, 18-20 wt.

In one embodiment, the immobilised waste material may comprise less than 10 wt % water, less than 8 wt % water, less than 5 wt % water, or even less than 3 wt % water.

In one embodiment, the immobilised waste material may have an unconstrained compression strength of 0.5 MPa or more. In some embodiments, the unconstrained compression strength of the immobilised waste material may be 0.05 MPa, 0.1 MPa, 0.15 MPa, 0.2 MPa, 0.3 MPa, 0.4 MPa, 0.5 MPa or more, and further in a range of 0.05-0.1 MPa, 0.1-0.15 MPa, 0.15-0.2 MPa, 0.2-0.3 MPa, 0.3-0.4 MPa, 0.4-0.5 MPa, or 0.5 MPa.

In another embodiment, the immobilised waste material may release less than 0.1% of total weight in free liquid organic waste when under a load of 0.05 MPa, 0.1 MPa, 0.15 MPa, 0.2 MPa, 0.3 MPa, 0.4 MPa, 0.5 MPa or more, and further in a range of 0.05-0.1 MPa, 0.1-0.15 MPa, 0.15-0.2 MPa, 0.2-0.3 MPa, 0.3-0.4 MPa, 0.4-0.5 MPa, or 0.5 MPa.

A still further aspect relates to use of kaolin for immobilising hazardous waste.

In some embodiments, the immobilisation of hazardous waste in a form suitable to store indefinitely in a repository at an approved site or facility by the process defined above may comply with the Basel Convention on the Control of Transboundary Movements of Hazardous Wastes and their Disposal and reduces the potential liability and compensation for third party damage or environmental damage.

Accordingly, in another aspect of the disclosure there is provided a method of issuing a Permanent Isolation Certificate, the method comprising the step of exploiting a process for immobilising hazardous waste defined by the first aspect of the invention and depositing the immobilised waste material produced by said process in a geological repository.

In a further aspect of the disclosure there is provided a method of issuing a Permanent Isolation Certificate, the method comprising the step of depositing an immobilised waste material defined by the second aspect of the invention in a geological repository.

The term ‘Permanent Isolation Certificate’ as used herein refers to a document attesting to a permanent isolation of a known quantity of hazardous waste in compliance with the Basel Convention. “Permanent isolation” in respect of a consignment of hazardous waste, refers to the permanent storage of said consignment in a geohydrologically isolated repository in a manner which separates the hazardous waste from the biosphere for geological periods of time.

### DESCRIPTION OF EMBODIMENTS

The disclosure relates to a process for immobilising hazardous waste, in particular persistent organic pollutants.

### General Terms

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Each example of the present disclosure described herein is to be applied mutatis mutandis to each and every other example unless specifically stated otherwise. The present disclosure is not to be limited in scope by the specific examples described herein, which are intended for the purpose of exemplification only. Functionally-equivalent products, compositions and methods are clearly within the scope of the disclosure as described herein.

The term “and/or”, e.g., “X and/or Y” shall be understood to mean either “X and Y” or “X or Y” and shall be taken to provide explicit support for both meanings or for either meaning.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

The term “about” as used herein means within 5%, and more preferably within 1%, of a given value or range. For example, “about 3.7%” means from 3.5 to 3.9%, preferably from 3.66 to 3.74%. When the term “about” is associated with a range of values, e.g., “about X % to Y %”, the term “about” is intended of modify both the lower (X) and upper (Y) values of the recited range. For example, “about 20% to 40%” is equivalent to “about 20% to about 40%”.

All percentages by weight in the compositions are percentages by weight with respect to the total composition.

### Specific Terms

The term ‘waste’ or ‘wastes’ as used herein refer to substances which are disposed of or are intended to be disposed of or are required to be disposed of by the provisions of national law. The waste may have any one or more hazardous characteristics selected from a group of characteristics comprising: explosive, flammable, liable to spontaneous combustion, emit heat or gases upon contact with water, oxidising, liable to exothermic self-accelerating decomposition (eg, organic peroxides), corrosive, poisonous (acute), toxic (delayed or chronic), ecotoxic, radioactive, or be capable, by any means, of yielding another material which possesses any of the aforementioned characteristics.

The term ‘liquid organic waste’ as used herein refers to waste which takes the form of a liquid, emulsion, sludge, and so forth and comprises or consists of organic contaminants, in particular organic compounds which are considered as hazardous and/or persistent organic pollutants.

The term ‘kaolin’ or Raolinite' as used herein refers to a clay mineral of the group of industrial minerals having the chemical composition Al₂Si₂O₅(OH)₄. Kaolinite is typically a layered silicate mineral having one tetrahedral sheet of silica (SiO₄) linked by oxygen atoms to one octahedral sheet of alumina (ALO₆) octahedra.

The term “persistent organic pollutants (POPs)” as used herein refers to any organic compound that is resistant to environmental degradation through chemical, biological and phytolytic processes and which consequently remain intact for exceptionally long periods of time (many years). The control of transboundary movements of hazardous wastes containing POPs and their disposal is governed by the Basel Convention.

The term ‘polychlorinated biphenyls’ as used herein has the same meaning as provided in Part IV of the Stockholm Convention on Persistent Organic Pollutants (POPs) and means aromatic compounds formed in such a manner that the hydrogen atoms on the biphenyl molecule (two benzene rings bonded together by a single carbon-carbon bond) may be replaced by up to ten chlorine atoms.

The term ‘polychlorinated dibenzo-p-dioxins’ and ‘polychlorinated dibenzofurans’ as used herein have the same meaning as provided in Part IV of the Stockholm Convention on Persistent Organic Pollutants (POPs) and refer to tricyclic, aromatic compounds formed by two benzene rings connected by two oxygen atoms in polychlorinated dibenzo-p-dioxins and by one oxygen atom and one carbon-carbon bond in polychlorinated dibenzofurans and the hydrogen atoms of which may be replaced by up to eight chlorine atoms.

The term ‘cementitious binder’ as used herein refers to a substance used for bonding aggregates and setting to a hard concrete material.

### Process for Immobilising Hazardous Waste

A number of multilateral environmental agreements provide frameworks to prevent and minimize release of toxic chemicals and hazardous wastes. The Basel, Stockholm and Rotterdam conventions collectively create a comprehensive life cycle approach to the management of hazardous chemicals and wastes. The process for immobilising liquid waste as described herein aims to comply with the provisions of the Stockholm Convention and the Basel Convention on the management of hazardous wastes including POP wastes so that such wastes, in particular liquid waste, may be handled, collected, transported and stored in an environmentally sound manner.

The process for immobilising hazardous waste as described herein produces an immobilised waste material which may be handled, collected, transported and stored in an environmentally sound manner.

The process comprises mixing said hazardous waste with a non-swellable clay, a cementitious binder and, optionally, water and allowing the resulting mixture to set to an immobilised waste material.

Swellable clays, such as smectites and montmorillonites, are 2:1 layer silicates which are widely used in a range of applications because of their swelling capacity, high surface area and resulting strong adsorption/absorption capacities. These clays have a high cation exchange capacity and may be converted to organo-clays or organophilic clays by replacement of the exchange ions by organic cations (or surfactants) thereby creating a hydrophobic or organophilic surface. For example, large hydrophobic quaternary ammonium compounds such as tetramethylammonium (TMA) and trimethylphenylammonium (TMPA) may be exchanged onto 2:1 layer silicate such that these swellable clays have greatly enhanced capacity to adsorb/absorb organic contaminants.

The inventors have surprisingly found that a non-swelling clay having a 1:1 silicate layer, in particular kaolin, may be used to adsorb/absorb hazardous waste, in particular liquid organic waste. Counterintuitively in comparison to swellable clays, kaolin may be used as received without any modification of the exchange ions within the 1:1 silicate layer lattice.

The kaolin may be milled to a particle size P₉₅<1000 μm, or a particle size P₉₅<500 μm, or even a particle size P₉₅<250 μm. The moisture content of the kaolin may be <1%.

In some embodiments, the non-swelling clay comprises a screened kaolinised granite comprising quartz and kaolinite. The particle size of the kaolinite may be <100 μm, although the quartz particles may be up to 20 mm.

The hazardous waste may first be dispersed in the kaolin to produce a dry mixture by mixing the hazardous waste and the kaolin with conventional mixers as will be well known to the skilled addressee. The term ‘dry mixture’ as used herein refers to a flowable particulate mixture with no free liquid generation when subjected to a load, for example a load of 0.5 MPa.

The amount of hazardous waste present in the dry mixture may vary according to the nature of the hazardous waste, in particular its viscosity and solids content. The hazardous waste may be present in the dry mixture in an amount such that there is no free liquid generation when the dry mixture is subjected to a load increment rate of 1 mm/min up to a load of 0.5 MPa.

Generally, the dry mixture may comprise up to 85 wt % hazardous waste. In some embodiments, the amount of hazardous waste in the dry mixture may be up to at least 10 wt %, 20 wt %, 30 wt %, 40 wt %, 50 wt %, 60 wt %, 70 wt %, 80 wt %, 83 wt % and 85 wt % and further in a range of at least 10 to 20 wt %, 20 to 30 wt %, 30 to 40 wt %, 40 to 50 wt %, 50 to 60 wt %, 60 to 70 wt %, 70 to 80 wt %, 80 to 83 wt %, 83-85 wt %.

The hazardous waste may comprise hazardous organic liquids or liquids contaminated with one or more hazardous organic compounds. Examples of such hazardous organic liquids include, but are not limited to, hydrocarbons, solvents, solvent recovery residues, waste from the production, formulation and use of inks, dyes, pigments, paints, lacquers and varnish, waste from the production of formulation and use of biocides and phytopharmaceuticals, waste from the manufacture, formulation and use of wood-preserving chemicals, wast containing peroxides other than hydrogen peroxide, hydraulic fluids, insulating fluids, engine oils, vehicle washwaters, transformer fluids, oil filters, waste tars and tarry residues arising from refining, distillation and any pyrolytic treatment, boiler blowdown sludge, cooling tower washwaters, textile effluent & residues, industrial plant washwaters, grease interceptor trap waste (domestic or industrial), liquid food waste including vegetable oils and derivatives, wool scouring waste, refrigerants, waste resulting from surface treatment of metals and plastics; waste pharmaceuticals, drugs and medicines, waste mineral oils unfit for their original intended use, waste from the production, formulations and use of resins, latex, plasticisers, glues and adhesives, organic cyanides, ethers, fire debris and fire washwaters, per- and poly-fluorinated compounds (PFAS), perfluorooctane sulfonate (PFOS), perfluorooctanoic acid (PFOS), halogenated organic solvents, highly odorous organic chemicals; organic phosphorus compounds, It will be appreciated that the hazardous organic liquids or liquids contaminated with one or more hazardous organic compounds may, or may not, also contain one or more POPs.

Alternatively, or additionally, the hazardous organic waste may comprise POPs. Examples of persistent organic pollutants include those organic compounds listed under Annexes A, B and C of the Stockholm Convention on POPs and include aldrin, chlordane, chlordecone, decabromodiphenyl ether, dieldrin, endrin, heptachlor, hexabromobiphenyl, hexabromocyclododecane (HBCDD), hexabromodiphenyl ether and heptabromodiphenyl ether, hexachlorobenzene (HCB), hexachlorobutadiene (HCBD), alpha hexachlorocyclohexane, beta hexachlorcyclohexane, lindane, mirex, pentachlorobenzene, pentachlorophenol and its salts and esters, DDT, perfluorooctane sulfonic acid, its salts and perfluorooctane sulfonyl fluoride, polychlorinated biphenyls (PCB), polychlorinated naphthalenes, short-chain chlorinated paraffins (SCCPs), technical endosulfan and its related isomers, tetrabromodiphenyl ether and pentabromodiphenyl ether, polychlorinated dibenzo-p-dioxins (PCDD) and polychlorinated dibenzofurans (PCDF).

Alternatively, or additionally, the hazardous waste may comprise one or more metals and/or inorganic compounds. Examples of such metals and inorganic compounds include, but are not limited to, antimony; antimony compounds; arsenic; arsenic compounds; asbestos; barium compounds (excluding barium sulphate); beryllium; beryllium compounds; boron compounds; cadmium; cadmium compounds; cerami-based fibres with physico-chemical characteristics similar to those of asbestos; chlorates; chromium compounds (hexavalent and trivalent); cobalt compounds; copper compounds; cyanides (inorganic); inorganic fluorine compounds excluding calcium fluoride; inorganic sulfides; isocyanate compounds; lead; lead compounds; mercury; mercury compounds; metal carbonyls; nickel compounds; phosphorus compounds excluding mineral phosphates; selenium; selenium compounds; tannery wastes (including leather dust, ash, sludges and flours); surface active agents (surfactants), containing principally organic constituents and which may contain metals and inorganic materials; tellurium, tellurium compounds; thallium; thallium compounds; triethylamine catalysts for setting foundry sands; vanadium compounds; zinc compounds.

Alternatively, or additionally, the hazardous waste may comprise one or more low level radioactive wastes such as NORMs. The term ‘naturally occurring radioactive materials’ (NORM) encompasses technologically enhanced naturally occurring radioactive materials (TENORM) and is used herein to refer to industrial wastes or by-products enriched with radioactive elements found in the environment, such as uranium, thorium and potassium and any of their decay products, such as radium and radon. NORMs may be produced by several industrial activities including, but not limited to, the extraction, production and use of rare earth elements and rare earth element alloys; mining and processing of ores; oil and gas production/removal and management of radioactive scales and precipitates; industrial activity utilising phosphate ore; manufacture of titanium dioxide pigments; extraction and refining of zircon and manufacture of zirconium compounds; production of tin, tantalum, copper, aluminium, zinc, lead and iron and steel; coal mine de-watering; china clay extraction; water treatment; underground mining and tunnelling; geothermal energy generation.

It will be appreciated that the hazardous waste may comprise a blend of any one or more of different types of hazardous waste as described above.

The dry mixture may then be mixed with the cementitious binder and sufficient water to produce a plastic mixture. The term ‘plastic mixture’ as used herein refers to a mixture in a freshly mixed state that is flowable and/or can be formed into any desired shape.

The cementitious binder may be a hydraulic cement selected from a group comprising Ordinary Portland cement (OPC), Portland-slag cement, Portland-pozzolan cement, calcined gypsum, gypsum plaster, Plaster of Paris, calcium sulphate hemihydrate, slag cement, natural cement, masonry cement, or sulphate-resistant cement, cement kiln dust, lime kiln dust, spent pot liner, or fly ash.

In particular the cementitious binder may be OPC. OPC is a finely ground material containing at least two thirds by mass calcium silicate phases, with the majority of the remainder being made of aluminium, iron and magnesium based phases. When a mixture of OPC and the dry mixture is further combined with water, a hydration reaction occurs and the resulting plastic mixture may be allowed to set to produce the immobilised waste material.

The plastic mixture may be allowed to set for a sufficient period of time for the immobilised waste material to achieve an unconstrained compression strength of 0.05 MPa or more. In some embodiments, the unconstrained compression strength may be 0.05 MPa, 0.1 MPa, 0.15 MPa, 0.2 MPa, 0.3 MPa, 0.4 MPa, 0.5 MPa or more, and further in a range of 0.05-0.1 MPa, 0.1-0.15 MPa, 0.15-0.2 MPa, 0.2-0.3 MPa, 0.3-0.4 MPa, 0.4-0.5 MPa, or 0.5 MPa. It will be appreciated that a desirable unconstrained compression strength may be selected depending on the depth at which the immobilised waste material may be stored underground. For example, to prevent subsidence, it may be desirable to provide an immobilised waste material having a greater unconstrained compression strength when it is stored in a geological repository up to 50 m below the surface and is subject to a load of overlying backfill material or further immobilised waste material. Alternatively, immobilised waste material stored closer to the surface and not subject to a high load, may be provided with a lower unconstrained compression strength.

The period of time may be up to 7 days. In some embodiments, the period of time may be 24 hours, 36 hours, 48 hours, 60 hours, 72 hours, 84 hours, 96 hours, or 7 days and further in a range of 24 to 96 hours, from 36 to 72 hours, or from 48 to 60 hours.

The plastic mixture may be compressed in a mould immediately after mixing and prior to allowing the plastic mixture to set. In this way, the resulting immobilised waste material may be conveniently shaped and sized to facilitate packing, transport and storage. For example, the plastic material may be compressed into standardised block moulds and allowed to set to the immobilised waste material. The blocks may be subsequently stacked for transport or storage.

Alternatively, the plastic mixture may be used to fill voids between packages of alternative solid waste materials stored in a repository and allowed to set to the immobilised waste material. In this way, storage space in the repository is used efficiently and the immobilised waste material provides strength and stability to the repository as a whole.

It will be also appreciated that the plastic mixture may be simply deposited as a layer on a floor of the repository and allowed to set.

In its solidified form, the immobilised waste material may comprise up to 80 wt % hazardous waste. In some embodiments, the amount of hazardous waste in the dry mixture may be up to at least 10 wt %, 20 wt %, 30 wt %, 40 wt %, 50 wt %, 60 wt %, 70 wt % and 80 wt %, and further in a range of at least 10 to 20 wt %, 20 to 30 wt %, 30 to 40 wt %, 40 to 50 wt %, 50 to 60 wt %, 60 to 70 wt %, 70 to 80 wt %.

In one embodiment, the immobilised waste material may comprises from 60 wt % to 80 wt % non-swelling clay.

In one embodiment, the immobilised waste material may comprise up to 20 wt % cementitious binder. In some embodiments, the amount of cementitious binder in the immobilised waste material may be up to at least 2 wt %, 5 wt %, 10 wt %, 12 wt %, 15 wt %, 18 wt % and 20 wt %, and further in a range of 2-5 wt %, 5-8 wt %, 8-10 wt %, 10-12 wt %, 12-15 wt %, 15-18 wt %, 18-20 wt.

In one embodiment, the immobilised waste material may comprise less than 10 wt % water, less than 8 wt % water, less than 5 wt % water, or even less than 3 wt % water.

In one embodiment, the immobilised waste material may have an unconstrained compression strength of 0.5 MPa or more. In some embodiments, the unconstrained compression strength of the immobilised waste material may be at least 0.05 MPa, 0.1 MPa, 0.15 MPa, 0.2 MPa, 0.3 MPa, 0.4 MPa, 0.5 MPa or more, and further in a range of 0.05-0.1 MPa, 0.1-0.15 MPa, 0.15-0.2 MPa, 0.2-0.3 MPa, 0.3-0.4 MPa, 0.4-0.5 MPa, or 0.5 MPa.

In another embodiment, the immobilised waste material may release less than 0.1% of total weight in free liquid organic waste when under a load of 0.05 MPa, 0.1 MPa, 0.15 MPa, 0.2 MPa, 0.3 MPa, 0.4 MPa, 0.5 MPa or more, and further in a range of 0.05-0.1 MPa, 0.1-0.15 MPa, 0.15-0.2 MPa, 0.2-0.3 MPa, 0.3-0.4 MPa, 0.4-0.5 MPa, or 0.5 MPa.

In one particular embodiment, the immobilised waste material may comprise from 10wt % to 20 wt % hazardous waste; 60 wt % to 80 wt % non-swelling clay; 10 wt % to 15 wt % cementitious binder, in particular from 12 wt % to 13 wt % cementitious binder; and less than 5 wt % water, or even less than 3 wt % water.

As will be evident from the foregoing description, hazardous waste may be immobilised in a form suitable to store indefinitely in a repository at an approved site or facility by the process defined above complies with the Basel Convention on the Control of Transboundary Movements of Hazardous Wastes and their Disposal and reduces the potential liability and compensation for third party damage or environmental damage.

A company that generates hazardous waste either directly or indirectly through its operations may transport the hazardous waste to a plant configured to perform the process as described herein to immobilise said hazardous waste material. On acceptance of the hazardous waste, a waste acceptance notice is first issued. The hazardous waste is then converted to the immobilised waste material as described herein and deposited in a geological repository to permanently isolate the immobilised hazardous waste material. A Permanent Isolation Certificate attesting to the permanent isolation of the hazardous waste in compliance with the Basel Convention is then issued.

The term ‘Permanent Isolation Certificate’ as used herein refers to a document attesting to permanent isolation of a known quantity of hazardous waste.

Typically the document is issued in respect of a hazardous waste consignment by an operator of the geological repository to the owner of the hazardous waste consignment. “Permanent isolation” means in respect of a consignment of hazardous waste, the indefinite storage and isolation below ground in a manner which separates the hazardous waste from the biosphere for geological periods of time.

The Permanent Isolation Certificate may be used by the company which generated said hazardous waste to demonstrate that a current financial liability incurred in connection with the transport and disposal of the hazardous waste has been reduced and/or a non-current financial liability for rehabilitation of a site contaminated with hazardous waste or potential legal liability and compensation for third party damage or environmental damage has been reduced or discharged. The Permanent Isolation Certificate may act as documentary evidence for the company's sustainability reporting, operational auditing and financial auditing, and may assist the company's entitlement to accounting treatment that allows the removal of contingent liability provisions in respect of the hazardous waste that has been immobilised. For example, under Australian laws, generators of hazardous waste have a “cradle to grave” responsibility for the waste. International (IA) and Australian Accounting Standards Board Provisions, Contingent Liabilities and Contingent Assets (AASB 137) require a waste producer to maintain an accounting provision equal to its best estimate of the future cost of properly disposing of that waste.

That provision represents a liability of the waste generator and a burden on its financial standing. It must be maintained until it is no longer probable that there will be any further cost involved in dealing with the waste. Further the provision must be reviewed periodically to ensure that it is adequate and adjusted if necessary. Following the issue of a Permanent Isolation Certificate, the waste generator no longer has any future costs that would meet criteria for recognition or disclosure under AASB 137. Hence the provision may be reversed.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

### EXAMPLES

The following examples are to be understood as illustrative only. They should therefore not be construed as limiting the invention in any way.

### Example 1 Immobilised Waste Material

Several samples of immobilised waste material with compositions as set out in Table 1 were produced from a waste liquid comprising transformer oil containing PCBs, kaolin, ordinary Portland cement (OPC), and water. The kaolin was white/off-white in colour and had been classified to pass through a 10 mm sieve. The moisture content of the kaolin was 1%.

The waste liquid was first mixed with the kaolin with no observable free liquid, and this resultant mixture was then mixed with OPC and water.

TABLE 1

| | 1A | 1B | 2A | 2B | 3A | 3B | 4A | 4B |
|---|---|---|---|---|---|---|---|---|
| OPC (g) | 375 | | | | | | | |
| Kaolin (g) | 2125 | | | | | | | |
| Waste (g) | 425 | | 510 | | 467.5 | | 446.25 | |
| Water (g) | 90 | | | | | | | |
| OPC (%) | 12.44 | | 12.10 | | 12.27 | | 12.35 | |
| Kaolin (%) | 70.47 | | 68.55 | | 69.5 | | 69.99 | |
| Waste (%) | 14.1 | | 16.45 | | 15.29 | | 14.70 | |
| Water (%) | 2.99 | | 2.90 | | 2.94 | | 2.96 | |
| Curing time (h) | 24 | 48 | 24 | 48 | 24 | 48 | 24 | 48 |
| UCS (MPa) | 0.451 | 0.567 | 0.41 | 0.48 | 0.385 | 0.504 | 0.497 | 0.566 |

### Example 2 Unconfined Compressive Strength Test

The unconfined compressive strength (UCS) of the immobilised waste material was tested in general accordance with Australian Standard AS5101.4. Several samples of immobilised waste material having compositions as set out in Table 1 were produced in accordance with the process described in Example 1. The ‘wet’ samples were poured into standard 1 L moulds and compacted in three (3) layers using 25 blows of a standard hammer. Two moulds were prepared for each ‘wet’ sample. The moulds were then allowed to air cure for 24 and 48 h, respectively, to produce an immobilised waste material monolith.

Each monolith's dimension and mass were recorded before being capped with rubber on the less planar side. The monolith was then loaded onto the compression machine and subjected to an increasing load at a rate of 1 mm/min. The maximum load at failure was then recorded. Table 1 summarises the results for the UCS tests.

### Example 3 Free Liquid Test

After completion of the UCS test, the monolith was crushed and placed into a CBR mould. Two annular CBR surcharges and a CBR disc was inserted on the surface of the test layer. The CBR mould having mass (M1), test specimen, baseplate, surcharge and spacer disc were placed on the load cell testing machine.

The test specimen was subjected to a load increment rate of 1 mm/min up to a load of 0.5 MPa. The CBR mould was left for three (3) minutes under load to assess the potential for free liquid generation under these conditions. The CBR mould and test specimen were removed from the compression machine. The surcharge and spacer discs were also removed from the CBR mould and it was re-weighed to determine final mass (M2). The difference between the two measurements M1 and M2 is the mass of free liquid generated. Any loss greater than 0.1% of total mass of tested sample was considered to have failed the free liquid test. Results of the free liquid test are provided in Table 2.

TABLE 2

| | Sample 3A | Sample 4A |
|---|---|---|
| Kaolin (% m/m) | 69.5 | 70.0 |
| PCB (% m/m) | 15.3 | 14.7 |
| OPC (% m/m) | 12.3 | 12.35 |
| Water (% m/m) | 2.9 | 3.0 |
| M1 (g) | 8480.1 | 8543.2 |
| M2 (g) | 8479.9 | 8542.9 |
| (M1 − M2) Free Liquid (g) | 0.2 | 0.2 |
| % Loss | 0.002 | 0.002 |
| Free Liquid < 0.1% | Pass | Pass |

1. A process for immobilizing hazardous waste comprising mixing said hazardous waste with a composition comprising non-swelling clay and a cementitious binder, and allowing the resulting mixture to set to an immobilized waste material.

2. The process according to claim 1, wherein the process comprises:
a) dispersing said hazardous waste in the non-swelling clay to form a dry mixture,
b) mixing the cementitious binder with the dry mixture to produce a plastic mixture; and
c) allowing the plastic mixture to set to the immobilized waste material.

3. The process according to claim 2, further comprising compressing the plastic mixture in a mold prior to step c).

4. (canceled)

5. The process according to claim 2, wherein the dry mixture comprises from 10 wt % to 25 wt % hazardous waste.

6.-13. (canceled)

14. The process according to claim 1, wherein the immobilized waste material comprises from 60 wt % to 80 wt % non-swelling clay.

15. The process according to claim 1, wherein the non-swelling clay comprises kaolin, and wherein the kaolin has a particle size P95<1000 μm.

16-18. (canceled)

19. The process according to claim 1, wherein the immobilized waste material comprises less than 10 wt % water.

20. The process according to claim 1, wherein the immobilized waste material has an unconstrained compression strength of at least 0.05 MPa.

21. The process according to claim 1, wherein the immobilized waste material releases less than 0.1% of total weight in free liquid when under 0.05 MPa load.

22. (canceled)

23. A method of issuing a Permanent Isolation Certificate, the method comprising the step of exploiting [[a]] the process for immobilizing liquid organic waste defined by claim 1 and depositing the immobilized waste material produced by said process in a geological repository.

24. (canceled)

25. An immobilized waste material comprising hazardous waste mixed with a composition comprising non-swelling clay and a cementitious binder.

26. The immobilized waste material according to claim 25, wherein the hazardous waste comprises persistent organic pollutants (POPs), hazardous organic liquids, liquids contaminated with one or more hazardous organic compounds, metals, inorganic compounds and/or naturally occurring radioactive materials.

27. The immobilized waste material according to claim 25, wherein the immobilized waste material comprises from 60 wt % to 80 wt % non-swelling clay.

28. The immobilized waste material according to claim 25, wherein the non-swelling clay comprises kaolin, and wherein the kaolin has a particle size P95 <1000 μm.

29. The immobilized waste material according to claim 25, wherein the immobilized waste material comprises at least 2 wt % cementitious binder, and wherein the cementitious binder comprises a hydraulic cement selected from the group consisting of Portland cement, Portland-slag cement, Portland-pozzolan cement, calcined gypsum, gypsum plaster, Plaster of Paris, calcium sulphate hemihydrate, slag cement, natural cement, masonry cement, sulphate-resistant cement, cement kiln dust, lime kiln dust, spent pot liner, and fly ash.

30. The immobilized waste material according to claim 25, wherein the immobilized waste material comprises less than 10 wt % water.

31. The immobilized waste material according to claim 25, wherein the immobilized waste material releases less than 0.1% of total weight in free liquid when under 0.05 MPa load.

32. The immobilized waste material according to claim 25, wherein the immobilized waste material has an unconstrained compression strength of at least 0.05 MPa.

33. A method of issuing a Permanent Isolation Certificate, the method comprising depositing an immobilized waste material defined by claims 25 in a geological repository.

34. The process according to claim 1, wherein said composition further comprises water.

35. The process according to claim 2, wherein water is mixed with the cementitious binder and the dry mixture to produce the plastic mixture.

36. The immobilized waste material according to claim 25, wherein said composition further comprises water.
